(19) United States
(12) Patent Application Publication
(10) Pub. No.: US 2010/0177048 A1
(43) Pub. Date: Jul. 15, 2010

(54) EASY-TO-USE SOFT KEYBOARD THAT DOES NOT REQUIRE A STYLUS

(75) Inventors: Anna L. Semenets, Redmond, WA (US); Darko Kirovski, Kirkland, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/352,678

(22) Filed: Jan. 13, 2009

(51) Int. Cl. G06F 3/041

(52) U.S. Cl. 345/173

(57) ABSTRACT

The claimed subject matter provides systems and/or methods that generates a soft keyboard projected onto a touch sensitive surface. The system includes components that form and associate groups of characters, symbols, numerals, letters, or punctuation to a small number of soft keys projected onto the touch sensitive surface, animates the groups of characters, symbols, numerals, letters, or punctuation assigned to the small number of soft keys, and obtains indication of a character, symbol, numeral, letter, or punctuation selected by a user when the user touches the surface while the groups of characters, symbols, numerals, letters, or punctuation are in animation.

### BACKGROUND

A touch screen is a display which detects the presence and/or location of a touch or tactile contact with a display area. The term generally refers to touch or contact with the display of the device by a finger or hand. Touch screens can also can also detect the presence or sense other passive objects such as a stylus. Touch screens typically have two main attributes. First, they enable one to interact with what is displayed directly on the screen, where it is displayed, rather than indirectly with a mouse or touch pad. Secondly, touch screens allow one to interact with whatever is being displayed without the necessity of an intermediate device, such as a stylus that may need to be held in the hand. Touch screen displays typically can be associated with computers, mobile phones, personal digital assistants (PDAs), satellite navigation devices, and a myriad of other portable and/or mobile devices.

With the advent of small form factor portable or mobile devices, such as the mobile or cellular telephone, Tablet PC, and the like, the continuing miniaturization of such small factor devices, and the constant demand for greater and more powerful and varied applications on such small form factor devices, a greater reliance on touch screen technology has emerged. In particular, many small form factor portable or mobile device manufactures have now started utilizing soft keyboards (also known as onscreen keyboards or software keyboards) that can replace the hardware keyboard typically associated with a computing device. Software keyboards are generally employed to enable input so that a keyboard does not have to be carried with it, and to allow people with disabilities or special needs to use computers. The displayed keyboard can usually be moved and resized, and generally can allow any input that the hardware version does.

Nevertheless, despite the manifest benefits of such soft keyboards the continued miniaturization of small form factor devices has led to an overall reduction in the space available to display such keyboards with a commensurate reduction in the size of the keys or buttons. This has meant that persons with large fingers or thumbs can find it difficult or impossible to navigate soft keyboards without the aid of a stylus or some other pointing implement (e.g., pens, pencils, . . . ) to facilitate the selection of keys on the soft keyboard.

### SUMMARY

The following presents a simplified summary in order to provide a basic understanding of some aspects of the disclosed subject matter. This summary is not an extensive overview, and it is not intended to identify key/critical elements or to delineate the scope thereof Its sole purpose is to present some concepts in a simplified form as a prelude to the more detailed description that is presented later.

The claimed subject matter in accordance with one or more aspects disclosed and/or described herein provides a soft keyboard that has large buttons and still shows a lot of the typing or display field. The claimed matter employs animation and hidden buttons/keys to provide the user all the scope and/or functionality of the traditional keyboard but in an easy-to-use and aesthetically appealing design. The large buttons are amenable to the use of fingers or thumbs regardless of size rather than utilization of a stylus that is currently a necessity with soft keyboards on many miniaturized mobile devices and especially those devices that attempt to provide a full QWERTY capability/functionality on a small form factor. Moreover, the hidden button/key facility of the claimed subject does not occlude the typing area as the hidden buttons/keys are only shown when they are required for access or use by the user. Furthermore, the soft keyboard disclosed and described also attempts to alleviate the boredom that some people can feel when typing as the soft keyboard can be implemented in calming color schemes and choices of disparate types of user interface to suit most user preferences.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that effectuates presentation of an easy to use soft keyboard in accordance with the claimed subject matter.

FIG. 2 provides a more detailed depiction of an illustrative keyboard engine that effectuates and facilitates that effectuates presentation of an easy to use soft keyboard in accordance with an aspect of the claimed subject matter.

FIG. 3 depicts a illustrative soft keyboard layout in accordance with an aspect of the claimed subject matter.

FIG. 4 provides a soft keyboard layout in accordance with a further aspect of the claimed subject matter.

FIG. 5 illustrates a further software keyboard layout in accordance with an aspect of the claimed subject matter.

FIG. 6 illustrates emoticons.

FIG. 7 depicts a soft keyboard emoticon editor in accordance with an aspect of the claimed subject matter.

FIG. 8 illustrates a flow diagram of a machine implemented methodology that effectuates and/or facilitates presentation of an easy to use soft keyboard in accordance with an aspect of the claimed subject matter.

FIG. 9 depicts a flow diagram of a machine implemented methodology that effectuates and/or facilitates presentation of an easy to use soft keyboard in accordance with an aspect of the claimed subject matter.

FIG. 10 illustrates a flow diagram of a machine implemented methodology that effectuates and/or facilitates presentation of an easy to use soft keyboard in accordance with an aspect of the claimed subject matter.

FIG. 11 illustrates a block diagram of a computer operable to execute the disclosed system in accordance with an aspect of the claimed subject matter.

FIG. 12 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

Many handheld touch-screen devices can require the use of a stylus for many people because of small button size. The stylus is generally inconvenient to use while moving, in a car, or if one hand is busy at any time. There are several types of keyboards that have attempted to alleviate these problems, but none have been particularly convenient to use and the buttons are nevertheless still too small. One implementation has attempted to guess what words the user wants from a dictionary, however, such a solution is unable to account for names or foreign words or language other than vernacular (e.g., slang). Another implementation has attempted to employ a keyboard similar to that currently utilized by cellular telephones wherein two or more letters are combined per key in the traditional keyboard layout. This latter implementation however has been found to be confusing and requires multiple clicks of the button or key in order to select the desired letter associated with the particular key.

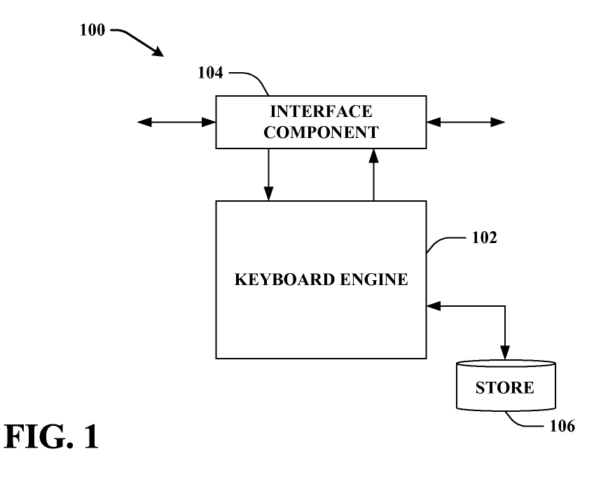

FIG. 1 depicts a machine-implemented system 100 that effectuates presentation of an easy to use soft keyboard in accordance with the claimed subject matter. As illustrated system 100 can include keyboard engine 102 that can receive input from interface component 104 in the form of whether or not a user has made tactile contact with a touch screen, where the user made tactile contact with the touch screen, how many times that the user made contact with the touch screen, whether or not the tactile contact was made relative to a soft keyboard that can have been generated and/or displayed by keyboard engine 102, where tactile contact has been made by the user relative to the soft keyboard projected by keyboard engine 102, to which letter (e.g., character, symbol, numeral, . . . ) the tactile contact corresponds, etc. Further, keyboard engine 102 can provide animation of letters or characters associated with keys or buttons included with the generated and/or projected soft keyboard. For instance, if the following letters or characters “w, x, y, and z” are assigned to a particular key or button included on the projected soft keyboard, keyboard engine 102 can animate the display of the letters so that each letter, character, numeral, or symbol is displayed in the button or key in a cyclical fashion. Thus, for example, the letter “w” can be displayed in the button or key for a specified amount of time (e.g., 0.5 seconds), after the specified amount of time has elapsed the letter “x” can be displayed, once again after the specified period “y” can be displayed, then the letter “z” can be displayed on effluxion of the specified period, after which the letter “w” can be displayed once again, etc.

In addition to the foregoing, on the basis that all letters or characters need not be displayed at all times, keyboard engine 102 can also estimate the possible number of characters and thus the number of keys that might be utilized by the user based at least in part on the possible words or word combination and/or permutations that can be generated. For instance, if the current input text (e.g., characters that have already been entered by the user into a display or typing area) is “ryo”, keyboard engine 102 can determine that only one key needs to be displayed for the letters or characters “k, a, n, and t” to form either the words “ryokan” (e.g., a traditional Japanese inn) or “ryot” (e.g., an Indian peasant or tenant farmer). In this functionality keyboard engine 102 can be aided by store component 106 that can include one or more online lookup dictionaries in addition to any suitable data necessary for keyboard engine 102 to facilitate it aims. For instance, store 106 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that store 106 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 102 of the subject systems and methods is intended to comprise, without being limited to, these and any other suitable types of memory. In addition, it is to be appreciated that store 102 can be a server, a database, a hard drive, and the like.

Furthermore in this endeavor, keyboard engine 102 can also be further aided through utilization of one or more artificial intelligence and/or machine learning techniques and/or technologies that can employ probabilistic based or statistical based approaches, for example, in connection with making determinations or inferences. Inferences can be based at least in part upon explicit training of classifiers or implicit training based at least in part upon system feedback and/or users' previous actions, commands, instructions, and the like during use of the system. The intelligence functionalities and facilities utilized by keyboard engine 102 can employ any suitable scheme (e.g., neural networks, expert systems, Bayesian belief networks, support vector machines (SVMs), Hidden Markov Models (HMMs), fuzzy logic, data fusion, etc.) in accordance with implementing various automated aspects described herein. Additionally, the artificial intelligence and machine learning aspects employed by keyboard engine 102 can further factor historical data, extrinsic data, context, data content, state of the user, and can compute costs of making an incorrect determination or inference versus benefits of making a correct determination or inference. Accordingly, a utility-based analysis can be employed with providing such information to other components or taking automated action. Ranking and confidence measures can also be calculated and employed in connection with such analysis.

Keyboard engine 102 can further include utilization of other components (not shown) that take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by keyboard engine 102 can include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

Moreover, keyboard engine 102 can also include utilization of one or more synthesizing aspects to combine, or filter information received from a variety of inputs (e.g., text, speech, gaze, environment, audio, images, gestures, noise, temperature, touch, smell, analog signals, digital signals, vibration, motion, altitude, location, GPS, wireless, etc.), in raw or parsed (e.g., processed) form. Such synthesizing aspects, through combining and filtering, can provide a set of information that can be more informative, or accurate (e.g., with respect to an entity's communicative or informational goals) than information from just one or two modalities, for example. As discussed with respect to the data fusion aspects above, which can be employed to learn correlations between different data types, the synthesizing functionalities can employ such correlations in connection with combining, or filtering the input data.

Additionally, keyboard engine 102 can include aspects that determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. Accordingly, the context determining aspects associated with keyboard engine 102 can provide current or historical data in connection with inputs to increase proper interpretation of inputs. For example, time of day may be helpful to understanding an input—in the morning, the word “drink” would likely have a high a probability of being associated with coffee, tea, or juice as compared to being associated with a soft drink or alcoholic beverage during late hours. Context can also assist in interpreting uttered words that sound the same (e.g., homonyms). Knowledge that it is near dinnertime of the user as compared to the user camping would greatly help in recognizing the following spoken words “I need a steak/stake”.

As stated above keyboard engine 102 can receive input from input component 104 and conversely can deliver output to interface component 104 for dissemination, utilization, and/or display to other components and devices. Interface component 104 (herein referred to as “interface 104”), that can provide various adapters, connectors, channels, communication pathways and/or modalities, etc. to integrate keyboard engine 102 into virtually any operating and/or database system(s) and/or with one another. Additionally, interface component 104 can provide various adapters, connectors, channels, communication pathways and/or methodologies, etc. to effectuate and facilitate interaction with and between keyboard engine 102 and any other component, data, and the like associated with system 100.

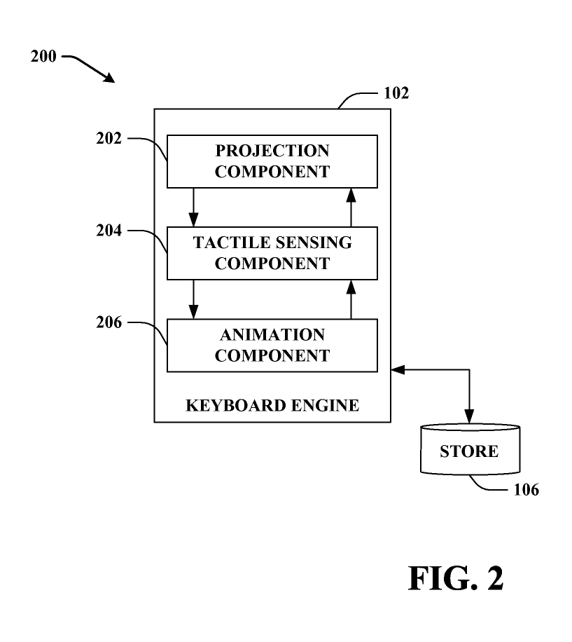

FIG. 2 provides a more detailed depiction 200 of an illustrative keyboard engine 102 that effectuates and facilitates presentation of an easy to use soft keyboard in accordance with an aspect of the claimed subject matter. As illustrated keyboard engine 102 can include projection component 202 that develops/generates a soft keyboard and dynamically and/or automatically updates a soft keyboard based at least in part on received or elicited user response. Additionally, projection component 202 can generate buttons and associate characters, numerals, symbols, and the like to each of the generated buttons. For instance, projection component 202 can determined that all the characters, symbols, numerals, etc. typically associated with keyboards, need to be displayed, and thus projection component 202 can allocate all the characters, symbols, numerals, etc. to a finite number of keys (e.g., 1-7, 2-9, 5-10, etc.) in order to both maximize the available display/typing space for other purposes and maximize button/key sizes so that persons with large fingers or thumbs can utilize the soft keyboard without inadvertently hitting unwanted keys/buttons. As will be appreciated, without limitation or loss of generality, by those relatively skilled in this area of endeavor, not all button/keys typically associated with a keyboard need be displayed in a contemporaneous manner, but rather projection component 202 in concert with other components, such as tactile sensing component 204, animation component 206, one or more dictionaries, lookup tables,and/or lookup dictionaries, and/or intelligence and/or machine learning aspects elucidated above, can dynamically and selectively populate keys with appropriate characters, symbols, numerals, and the like, so as to maximize button size while at the same time ensuring that the available surface area for display or other functionalities and/or typing spaces is also maximized.

Projection component 202 in addition can be responsible for the layout of the overall touch screen display, and in particular, presentation of the soft keyboard. In accordance with one aspect of the claimed subject matter, projection component 202 can present a soft keyboard where button/keys with associated characters, symbols, numerals, etc. are presented down the left hand margin of the available touch screen display leaving the greater part of the touch screen display for a typing area or other functionalities. Alternatively, projection component 202 can present a soft keyboard where buttons/keys with associated characters, symbols, numerals, and the like, can be disposed down the right hand margin of the available touch screen display, once again leaving the greater part of the touch screen display available for typing areas or other functionalities. As will be evident to those of moderate comprehension, disposing buttons/keys down a right hand margin can facilitate easier access by individuals who are left handed or where text flows from right to left (e.g., Arabic, . . . ). In a similar fashion, projection component 202 can present a soft keyboard where buttons/keys with associated characters, symbols, numerals, and the like, can be disposed across the top and/or bottom margins of the available touch screen display once again leaving the greater part of the touch screen display available for typing areas or other functionalities. As will be clearly appreciated, projection component 202 can orient and position the buttons/keys of the soft keyboard in any desired position (e.g., diagonally) in order to maximize the size of the available display as well the size of the buttons/keys.

Keyboard engine 102 can also include tactile sensing component 204 that can detect the presence of a person's fingers and/or thumbs in contact with and/or hovering over a touch screen display. Additionally, tactile sensing component 204 can also detect the number of times that the person's fingers and/or thumbs come in contact with or hover over the touch screen display, as well as identifying the positional coordinates of such contact or hovering (e.g., tactile sensing component 204 can determine which button/key the person tapped, touched, hovered over, and how many times the button/key was tapped, touched, or hovered over).

Further, keyboard engine 102 can also include animation component 206 that can cause numerals, characters, symbols, etc. associated (e.g., by projection component 202) with keys/buttons to become animated. In accordance with one aspect of the claimed subject matter, characters, numerals, symbols, etc. associated with buttons/keys can be presented in constant animation wherein each character, numeral, symbol, associated with a particular key can continuously be cycled through. For example, assume that projection component 202 has assigned the letter “a”, “b”, “c”, and “d” to a particular key/button. Animation component 206 can cause each letter “a”, “b”, “c”, and “d” to be displayed one at a time in the button/key corpus for a finite user configurable period of time (e.g., 0.75 seconds). Thus, “a” can be displayed in the button/key corpus for 0.75 seconds, after which “b” can replace “a” and be displayed for 0.75 seconds, then “c” can replace “b” and be presented in the key/button corpus for another 0.75 seconds, after which “d” can replace “c” and be represented in the button/key corpus for 0.75 seconds, at which point “a” can replace “d” and be displayed for 0.75 seconds. This cycling through assigned characters, numerals, symbols, etc. can be performed continuously, until the user makes a selection from a key/button which is detected by tactile sensing component 204. When the user makes a selection the number, character, or symbol being displayed or presented at the time of the selection is the one that the user has identified as being desirous. When the user has identified the appropriate number, character, symbol, etc., from the appropriate key/button (e.g., by touching the screen or hovering his/her finger or thumb over the area in which the button/key has been displayed by projection component 202) the number, character, symbol, etc. can be presented in the assigned display/typing area by projection component 202.

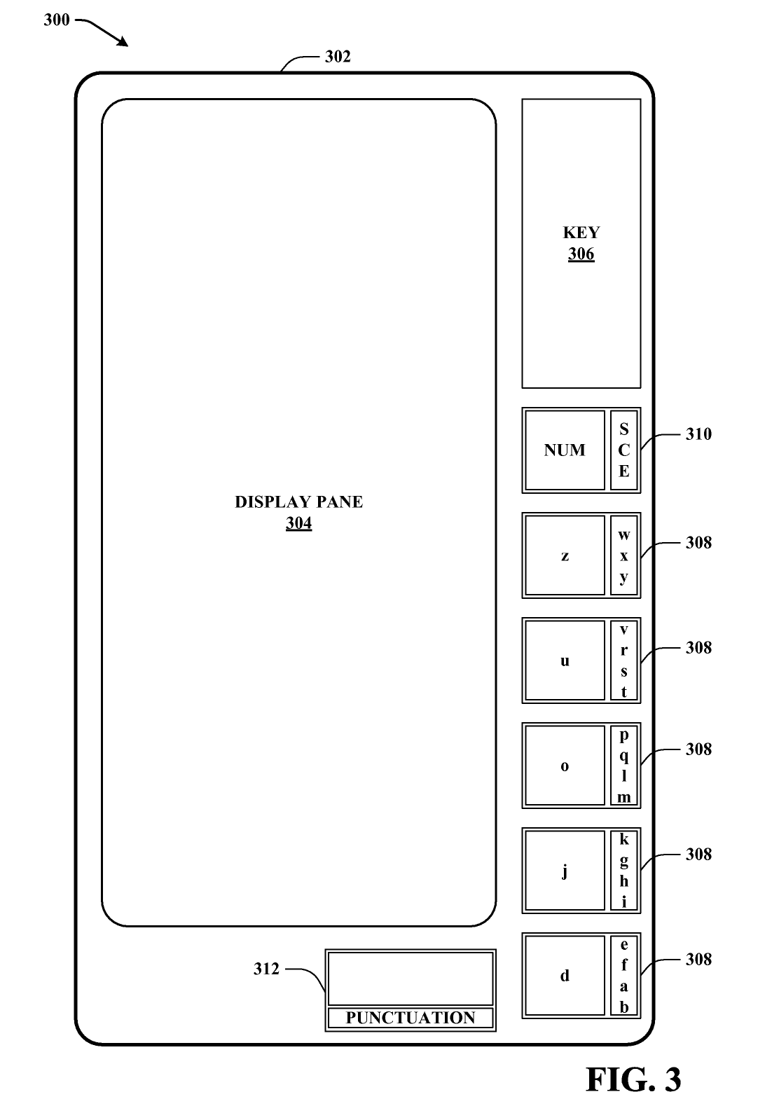

FIG. 3 depicts an illustrative soft keyboard layout 300 in accordance with an aspect of the claimed subject matter. Software keyboard layout 300 can be a result of utilization of keyboard engine 102 and its components set forth above. Soft keyboard layout 300 can be presented on a touch screen 302 that includes a display pane 304 that can present text that a user has entered using the soft keyboard layout 300, as presented herein, and projected on touch screen 302. Soft keyboard layout 300 can also include key 306 that can be utilized to provide keyboard functionalities such as delete, backspace, enter, and the like. For example, in accordance with one aspect of the claimed subject matter, key 306 can be implemented such that backspace requires the user to use his/her finger to perform a right to left sliding motion inside the representation of key 306, delete requires the user to perform sliding his/her finger from the top to the bottom of key 306, and the enter functionality can be accomplished by the user performing a tapping motion in the key 306 bounded area.

Further, illustrative soft keyboard layout 300 can also include keys/buttons 308 that can be variable in number depending on how keyboard engine 102 and its associated components decide to present keys/buttons 308. As illustrated, keyboard engine 102 has presented five keys/buttons 306 wherein the full spectrum of the lower case alphabet (e.g., a-z) is to be presented. Each of the five keys/buttons 308 can be partitioned into a left hand portion and a right hand portion. In the right hand portion of key/button 308 the totality of the letters assigned to a key/button 308 can be displayed and in the left hand portion of key/button 308 each of letters assigned to the key/button 308 can be individually displayed one at a time according to a user and/or machine determined schedule. For example, where key/button 308 has been assigned (e.g., by keyboard engine 102) the letters “w”, “x”, “y”, and “z”, the letters “w”, “x”, and “y” can be displayed in the right hand portion of the key/button 308, and the letter “z” can be displayed in the left hand portion of button/key 308. Letters appearing in the left hand portion of key/button 308 generally indicate that the letter appearing therein is the one that will be selected for entry into display pane 304 should the user touch the key while the letter is being displayed. Thus, should a user touch or hover over the key/button 308 associated with the letters “w”, “x”, “y”, and “z” with his/her finger or thumb while “z” is being displayed in the left hand portion key/button 308, then the letter “z” will be selected and entered into the display pane 304. It should be noted that the right and left hand portions of the key/button can be reversed wherein the totality of the letters, symbols, numbers, etc. assigned by keyboard engine 102 to each key/button can be presented in the left hand portion of the key/button 308 and the letter to be selected is displayed in the right hand portion of the key/button 308. It should also be further noted that the individual letter that appears in the left or right portion of key/button 308, as circumstances dictate, can be cycled through one at a time.

Additionally, soft keyboard layout 300 can also include key/button 310 and key/button 312. Key/button 310 can be utilized to provide functionality for selecting between numerals (e.g., 0-9), mathematical operators (e.g., +, −, ×, ÷, ±, ≠, etc.), disparate language character sets (e.g., Greek, Coptic, Cyrillic, Symbols, . . . ), assorted character sets (e.g., Arial, Times Roman, and the like), switching between upper case and lower case characters, changing font color, changing font size, providing underlining, strikethroughs, italicizing previously and/or subsequently selected text, and the like. Key/button 312 can provide for functionalities such as supplying punctuation as well as providing facilities to provide spaces (e.g., a space bar). The functionality with regard to providing the various animation aspects associated with these keys/buttons (e.g., key/button 310 and key/button 312) in a round robin manner can be substantially similar to that described in relation to keys/buttons 308, and accordingly in order to avoid needless prolixity the discussion of this functionality has been avoided.

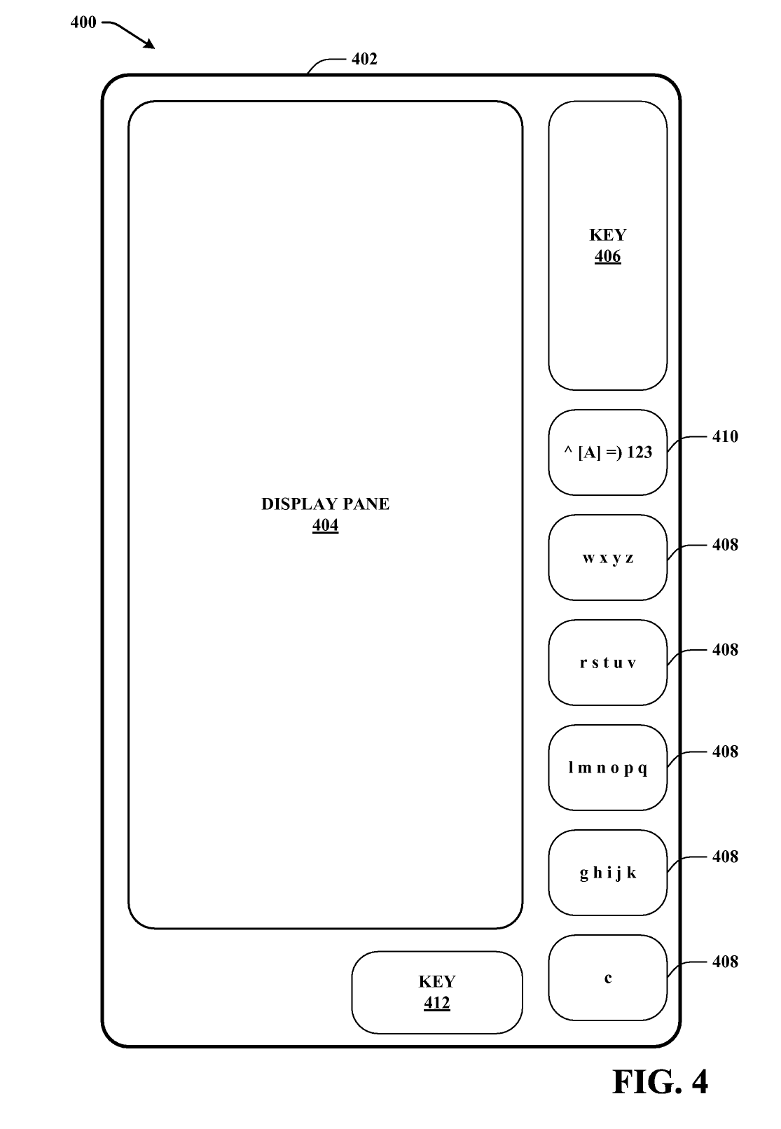

FIG. 4 provides a soft keyboard layout 400 in accordance with a further aspect of the claimed subject matter. As will be observed upon viewing soft keyboard layout 400, the layout and functionalities of the keys is very much the same or similar as those described in connection with FIG. 3, however, as will be further noted in accordance with this aspect of the claimed matter, keys/buttons 408-412 do not have a left and right portion (or in the case of 412 upper and lower portions), but rather present all the letters, symbols, and characters at the same time until the key/button is activated by the user by either touching the key/button or hovering over the key/button with his/her finger or thumb at which point the letters, symbols, numerals, and characters assigned and/or associated with the activated key can commence cycling through and be displayed one at a time in the key/button. The user identifies or selects the appropriate letter, symbol, character, etc. by touching or tapping the button/key a second time at which point the selected letter, character, symbol, numeral, etc. can be represented in display pane 404.

It should be noted without limitation or loss of generality that the distinction between the button/key configuration presented in FIG. 3 and FIG. 4 lies in the fact that the assigned symbols, numerals, punctuation, letters, characters, etc. associated with key/buttons 308-312 in FIG. 3 can be in constant animation wherein the assigned symbols, numerals, punctuation, letters, characters, etc. are in constant rotation in their respective keys/buttons, whereas with key/buttons 408-412 the assigned symbols, numerals, punctuation, letters, characters, etc. associated with key/buttons 408-412 become animated (e.g., commence cycling one at a time in their assigned key/button) when the user initially touches the key/button or hovers over the key/button with his/her finger or thumb and cease to be animated once the user touches, taps, or hovers his/or finger over the animated key/button a second time to select a character, numeral, symbol, and the like, to be presented in display pane 404. As will be evident to those reasonably skilled in the art a further distinction between FIG. 3 and FIG. 4 lies in the fact that in FIG. 4 only keys/buttons that have been activated by the user will be animated which can mean that no key is undergoing animation or one or more keys/buttons are animated at any give time. In contrast, in FIG. 3 animation continuously takes place with respect to all keys/button capable of performing the animation functionality.

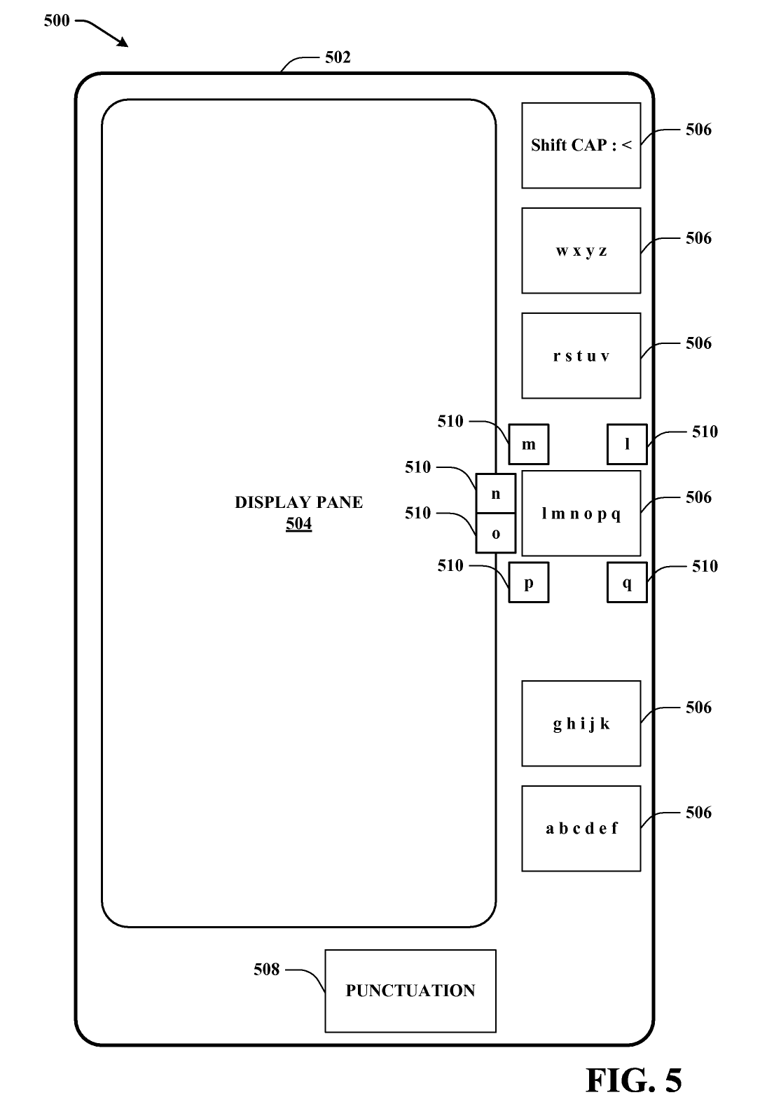

FIG. 5 illustrates a further software keyboard layout 500 in accordance with an aspect of the claimed subject matter. Because much of the configuration and operation of software keyboard layout 500 is substantially similar to that described with respect software keyboard layout 300 and software keyboard layout 400, a detailed description of such features has been omitted to avoid needless repetition and for the sake of brevity and conciseness. Nevertheless, in addition to display pane 504 the functionality of which have been expounded upon above in connection with FIG. 3 and FIG. 4, software keyboard layout 502 can include keys/buttons 506 and button/key 508 that can operate in the following manner. Like keys/buttons 408-412 presented in FIG. 4, keys/buttons 506 and key/button 508 do not have a left and right portions (or in the case of key/button 508 upper and lower portions), but rather present all the letters, symbols, punctuation, and characters at the same time until the key/button is activated by the user by either touching the key/button or hovering over the key/button with his/her finger or thumb at which point buttons/keys 510 can be deployed and displayed. The further buttons/keys 510 include the individual letters, symbols, numerals, punctuation, and characters assigned and/or associated with the activated key. For example, as illustrated in FIG. 5, buttons/keys 510 have been deployed due to the activation of the key/button 506 that includes the characters “l”, “m”, “n”, “o”, “p”, and “q”, as such when this key/button 506 is activated, buttons/keys 510 can be deployed and/or activated wherein each displayed key/button 510 contains each character assigned and/or associated with the activated key (e.g., “l”, “m”, “n”, “o”, “p”, and “q”). When these activated keys/buttons 510 are deployed the user can use his/her finger or thumb to move in the direction of the desired letter, character, symbol, numeral, etc. For instance, if the user wishes to select the letter “l” he/she would move (slide) their finger in the northeasterly direction towards the key/button displaying the desired letter. Alternatively and/or additionally, the user could tap the desired key/button 510. Once selected the letter can be displayed in display pane 504 and the deployed and displayed keys/buttons 510 placed in a concealed state (e.g., the keyboard engine 102 can redraw the software keyboard layout 502 so that the keys/buttons 510 are no longer visible thus no longer available for selection).

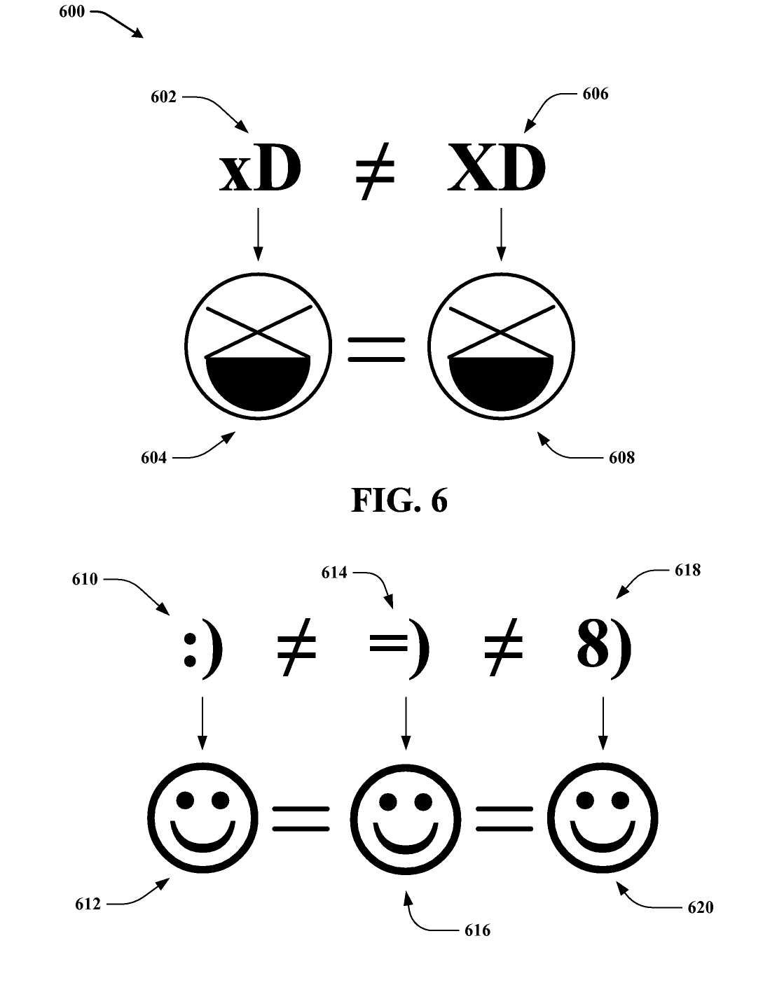

FIG. 6 illustrates emoticons 600 in accordance with an aspect of the claimed subject matter. Text emoticon 602 when typed into most text editors is automatically and typically converted into the graphical representation 604. Similarly, text emoticon 606 is typically converted into graphical emoticon 608. As will be observed the graphical emoticons 604 and 608 are identical representations, but the text emoticons 602 and 606 are different and distinct, and in fact can convey greater or lesser emotions. Similarly, text emoticons 610, 614, and 618 will typically be converted into the graphical emoticons 612, 616, and 620, however the text emoticons 610, 614, and 618 do not necessarily represent or convey an identical degree of emotion (or even the same emotion) as does the graphical emoticons 612, 616, and 620. Moreover, there currently are textual emoticons that do not have graphical emoticon equivalents. Accordingly, the claimed subject matter presents a soft keyboard emoticon editor that can be employed to create or construct text emoticons that can communicate or express a full range of emotions and hidden meanings that the text emoticons can convey.

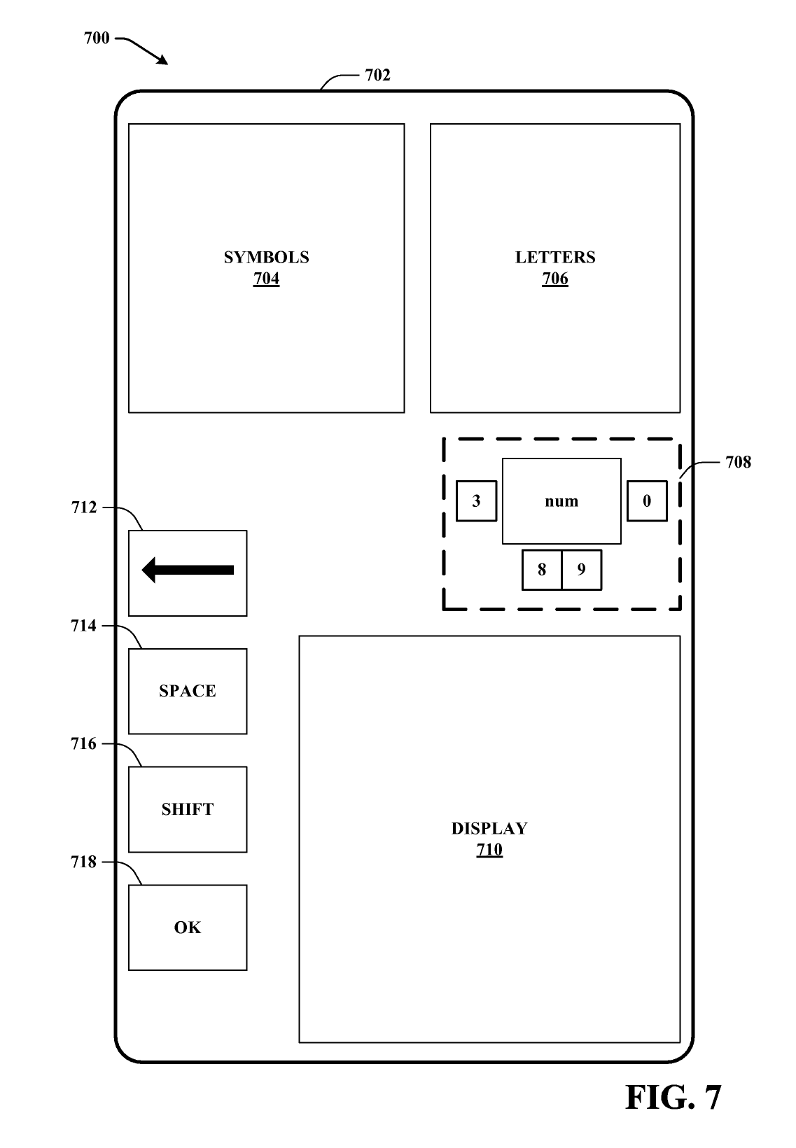

FIG. 7 depicts a soft keyboard emoticon editor 700 in accordance with an aspect of the claimed subject matter. As illustrated, soft keyboard emoticon editor 700 can be presented on a touch screen 702 associated with, for example, a mobile device, such as a cellular telephone, smart phone, laptop computer, personal digital assistant (PDA), consumer appliances and/or instrumentation, portable industrial devices and/or components, hand-held devices, multimedia Internet enabled phones, multimedia players, and the like. Touch screen 702, or more particularly soft keyboard 700 as graphically rendered by keyboard engine 102 within the boundaries of touch screen 702, can include symbols area 704 which can include all the symbols necessary to construct and/or edit textual emoticons, such as “˜”, “̂”, “—”, “@”, “\”, “:”, “;”, “(”, “)”, and the like. Typically utilized symbols can be presented as individual keys/button within the area prescribed for symbols 704, whereas further less commonly employed symbols can be presented utilizing the button/key concepts elucidated in relation to FIGS. 3-5. Further, touch screen can also include letters area 706 wherein all the letters necessary to create and/or edit textual emoticons can be displayed. Commonly employed letters can be presented as individual keys/buttons within the boundaries of letters area 706 whereas less commonly utilized letters can be presented in one of more button/key configurations expounded upon in connection with FIGS. 3-5 above. Additionally, soft keyboard 700 as rendered on touch screen 702 can include a numbers area 708 that can include buttons/keys for numbers that are commonly utilized in the creation or editing of text emoticons (e.g., 0, 3, 8, and 9) as well as a key/button which can be utilized for numerals that are not so frequently utilized in the construction or editing of emoticons. The key/button that is utilized for less commonly employed numerals can utilize one or more of the button/key configurations and functionalities described above in connection with FIGS. 3-5. Additional buttons/keys can also be presented in the soft keyboard layout for emoticons 700. These buttons can include backspace key/button 712, space button/key 714, shift key/button 716 (e.g., to shift between uppercase and lower case letters), and an “OK” button/key utilized to indicate that the user has completed creating or editing emoticons. Further, to allow the user to view the multiple characters that he/she has utilized to construct or edit an emoticon or to view emoticons that he/she has previously utilized and/or constructed, a display area 710 can be provided. It should be appreciated and noted, without limitation or loss of generality, textual emoticons can be composed of multiple numbers, symbols, and letters, such as “- - - w - - - ”, or “>w<”, which can be utilized to represent a smiling cat with large incisors.

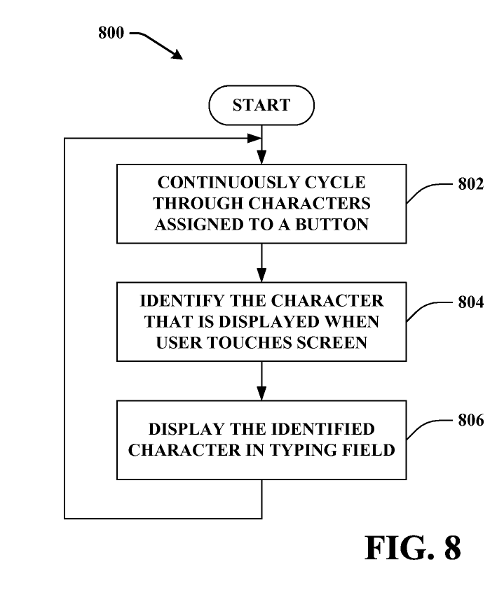

In view of the illustrative systems shown and described supra, methodologies that may be implemented in accordance with the disclosed subject matter will be better appreciated with reference to the flow charts of FIGS. 8-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 8 illustrates a flow diagram of a machine implemented methodology 800 that effectuates and/or facilitates presentation of an easy to use soft keyboard in accordance with an aspect of the claimed subject matter. Methodology 800 can commence at 802 where characters, symbols, numerals, punctuation, etc. associated with buttons/keys generated and displayed by keyboard engine 102 can be continuously cycled within their assigned buttons/keys. At 804 method 800 can await the user to touch or hover his/her finger or thumb over a key/button and monitor or identify the character, symbol, numeral, punctuation, etc. that is displayed at the time the user touches or hovers his/her finger or thumb over the key/button. At 806 the identified character, symbol, numeral, punctuation, etc. can be displayed in an associated display area at which time methodology 800 can return to 802.

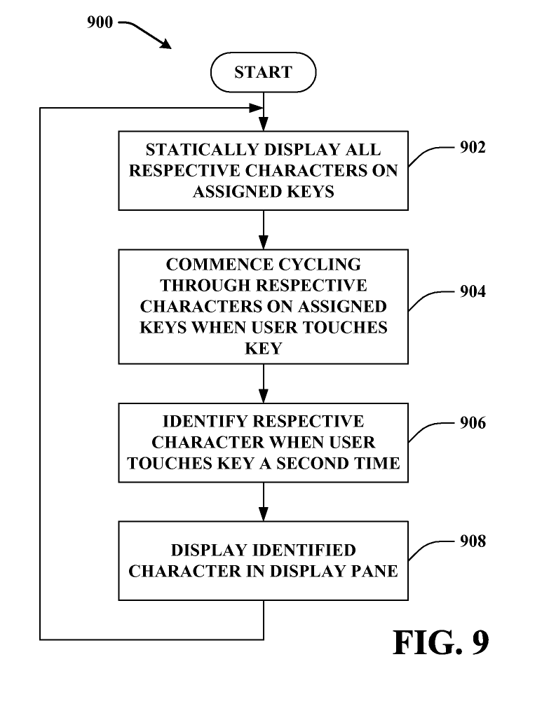

FIG. 9 depicts a flow diagram of a machine implemented method 900 that effectuates and/or facilitates presentation of an easy to use soft keyboard in accordance with an aspect of the claimed subject matter. Method 900 can commence at 902 where characters, symbols, numerals, punctuation, etc. associated with buttons/keys generated and displayed by keyboard engine 102 can be statically displayed within their assigned buttons/keys. At 904 the characters, symbols, numerals, punctuations, etc., associated with buttons/keys assigned, generated and displayed by keyboard engine 102 can be animated (e.g., the characters, symbols, numerals, punctuations, etc. can commence cycling in a round bobbin fashion) when a user selects a key/button via touch. At 906 method 900 can await the user to touch or hover his/her finger or thumb over the key/button a second time and can monitor or identify the character, symbol, numeral, punctuation, etc. that is displayed at the time the user touches or hovers his/her finger or thumb over the key/button at that point. At 908 the identified character, symbol, numeral, punctuation, etc. can be displayed in an associated display pane after which method 900 can return to 902.

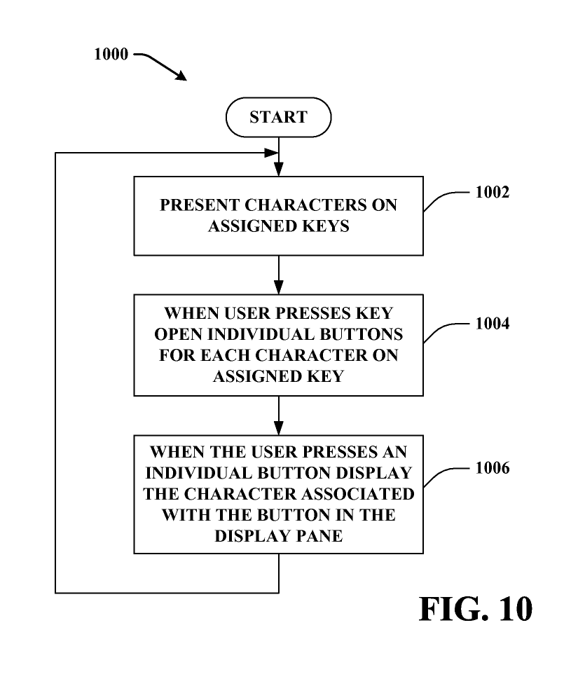

FIG. 10 illustrates a flow diagram of a machine implemented methodology 1000 that effectuates and/or facilitates presentation of an easy to use soft keyboard in accordance with an aspect of the claimed subject matter. Methodology 1000 can commence at 1002 where characters, symbols, numerals, punctuation, etc. associated with buttons/keys generated and displayed by keyboard engine 102 can be displayed within their assigned buttons/keys. At 1004 method 1000 can await the user to touch or hover his/her finger or thumb over the key/button at which point sub-keys/buttons associated with each of the characters, symbols, numerals, punctuation, etc. associated or assigned by keyboard engine 102 to the key/button can be displayed. At 1006 method 1000 can monitor or identify the sub-key/button associated with a character, symbol, numeral, punctuation, etc. that the user touches or hovers his/her finger or thumb over and the identified character, symbol, numeral, punctuation, etc. can be displayed in an associated display pane, at which point the method can cycle back to 1002.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

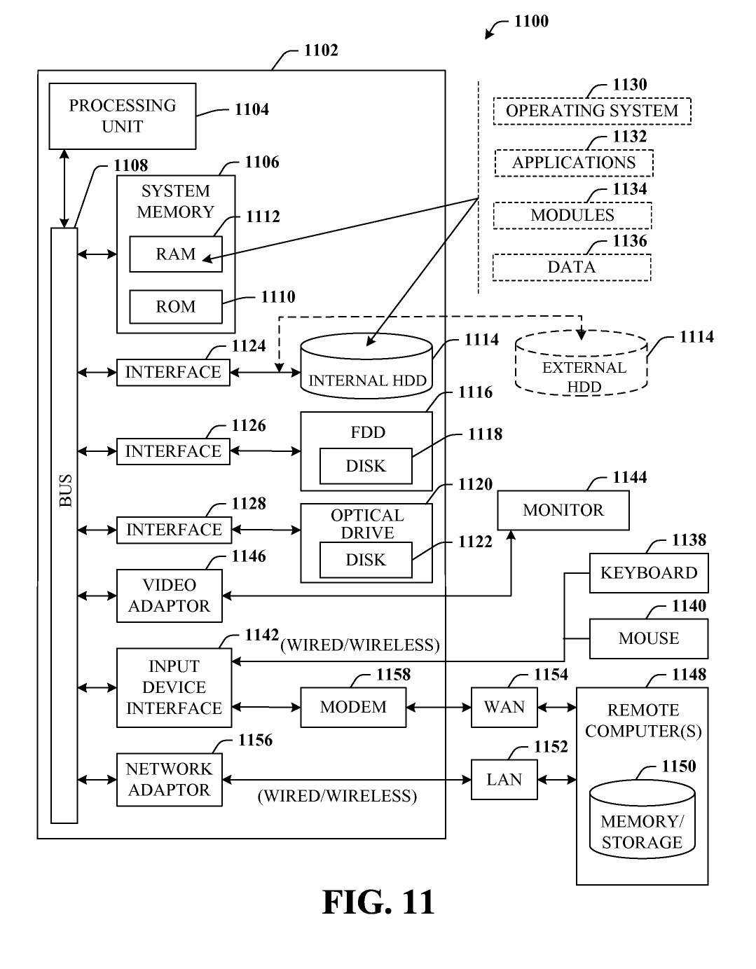

Referring now to FIG. 11, there is illustrated a block diagram of a computer operable to execute the disclosed system. In order to provide additional context for various aspects thereof, FIG. 11 and the following discussion are intended to provide a brief, general description of a suitable computing environment 1100 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the illustrative environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the claimed subject matter can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1094 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are illustrative and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

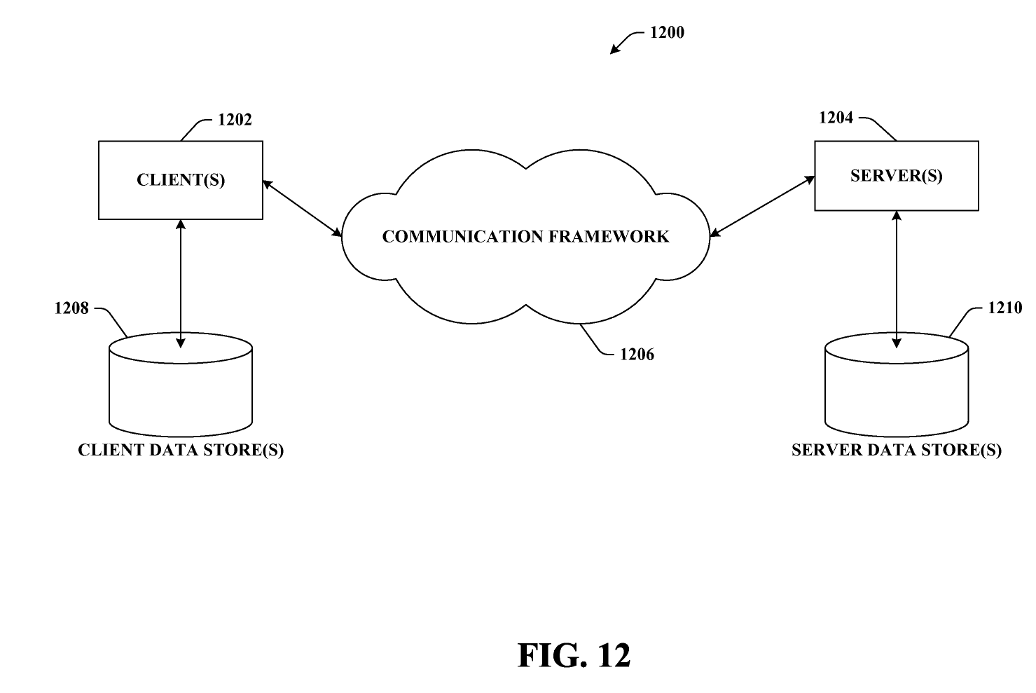

Referring now to FIG. 12, there is illustrated a schematic block diagram of an illustrative computing environment 1200 for processing the disclosed architecture in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that generates a soft keyboard, comprising:
a keyboard engine that forms at least one grouping of characters, the grouping of characters allocated to one or more soft keys that the keyboard engine projects onto a touch screen display; and
an interface that receives indication from a user of the one or more soft keys that is selected, the indication provided by at least one of the user's finger or thumb.

2. The system of claim 1, the keyboard engine continuously and individually cycles each character included in the grouping of characters associated with the one or more soft keys within a boundary for the soft key determined by the keyboard engine.

3. The system of claim 1, prior to continuously and individually cycling each character included in the grouping of characters associated with the one or more soft keys, the keyboard engine waits for the indication from the user as to which grouping of characters associated with the one or more soft keys is selected by the user's finger or thumb.

4. The system of claim 1, the at least one of the user's finger or thumb at least one of touches the one or more soft keys projected onto the touch screen display or hovers over the one or more soft keys projected onto the touch screen display.

5. The system of claim 1, the keyboard engine determines the at least one grouping of characters to associate with the one or more soft keys based at least in part on at least one previously selected character projected by the keyboard engine into a display area included in the soft keyboard projection.

6. The system of claim 5, the keyboard engine determines the at least one grouping of characters to associate with the one or more soft keys based at least in part on input received from a lookup reference.

7. The system of claim 1, the keyboard engine waits for the indication from the user as to which grouping of characters associated with the one or more soft keys is selected and projects further soft keys onto the touch screen display, the further soft keys projected by the keyboard engine to be contiguous to the one or more soft keys, each of the further soft keys includes a character included in the grouping of characters associated with the one or more soft keys as determined by the keyboard engine.

8. The system of claim 1, the keyboard engine forms the at least one grouping of characters based at least in part on whether the characters are one of letters, numerals, symbols, or punctuation, each of the at least one grouping of characters that include one of letters, numerals, symbols, or punctuation projected as individual blocks to include only one or more of letters, numerals, symbols, or punctuation, each of the individual blocks that include only one or more of letters, numerals, symbols, or punctuation utilized to construct textual emoticons.

9. A method implemented on a machine that generates a soft keyboard, comprising:
employing at least one processor to form a grouping of characters;
associating the grouping of characters to a soft key;
projecting the soft key onto a surface; and
obtaining an indication from a user touching the surface signifying a selection of a character included in the grouping of characters.

10. The method of claim 9, the projecting further comprising constantly cycling through each of the characters included in the grouping of characters within a boundary of the soft key.

11. The method of claim 9, the projecting further comprising statically displaying the grouping of characters within a boundary of the soft key.

12. The method of claim 11, further comprising commencing constantly cycling through each of the characters included in the grouping of characters within the boundary of the soft key.

13. The method of claim 12, the commencing constantly cycling through each of the characters contingent on the user touching the surface.

14. The method of claim 9, the touching of the surface signifying the selection of a character performed by at least one of the user's finger or thumb, the selection of the character predicated on the user identifying the character as each of the characters included in the grouping of characters is periodically cycled and displayed one at a time within a boundary of the soft key, the character selected is projected and displayed in a display area

15. The method of claim 9, the grouping of characters based at least in part on a presence of at least one previously selected character included in a display area projected onto the surface.

16. The method of claim 9, the grouping of characters further comprising utilizing at least one of a lookup dictionary or a lookup table.

17. The method of claim 9, further comprising waiting for the user to touch the surface where the soft key is projected, when the user touches the surface projecting one or more further soft keys onto the surface, each of the one or more further soft keys includes a character included in the grouping of characters.

18. The method of claim 17, the one or more further soft keys projected in close proximity to where the soft key is projected.

19. A system that generates a soft keyboard, comprising:
a memory that retains instructions related to employing at least one processor to form a grouping of characters, associating the grouping of characters to a soft key, projecting the soft key onto a tactile surface, and obtaining an indication from a user touching the tactile surface signifying a selection of a character included in the grouping of characters; and
a processor, coupled to the memory, configured to execute the instructions retained in the memory.

20. The system of claim 19, the memory further retains instructions related to segregating the grouping of characters based on a classification of whether the characters are one of letters, numerals, symbols, or punctuation, each of the grouping of characters that are one of letters, numerals, symbols, or punctuation projected onto the tactile surface as blocks of one of letters, numerals, symbols, or punctuation, each of the blocks of one of letters, numerals, symbols, or punctuation employed to edit textual emoticons projected onto the tactile surface, previously created or edited textual emoticons cached in a display area, the previously created or edited textual emoticons available for use by the user touching the tactile surface corresponding to the textual emoticon presented in the display area.
